(19) United States
(12) Patent Application Publication
(10) Pub. No.: US 2010/0305263 A1
(43) Pub. Date: Dec. 2, 2010

(54) CROSS-LINKABLE MASSES COMPRISING PHOSPHORUS COMPOUNDS

(75) Inventor: Marko Prasse, Glaubitz (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/599,191

(22) PCT Filed: May 9, 2008
(86) PCT No.: PCT/EP2008/055729

§ 371 Date: Nov. 6, 2009

(30) Foreign Application Priority Data
May 23, 2007 (DE) 10 2007 023 932.9

(51) Int. Cl. C08L 83/04

(52) U.S. Cl. 524/547; 525/474; 524/588

(57) ABSTRACT

Compositions that can be cross-linked by a condensation reaction comprise an organic polymer having at least one organyloxysilyl radical (A) and compounds (B) of the formula (I) [R₄P⁺]ₛX⁵⁻, wherein X is a group of the formula (II) O═PR¹ₙ(O⁻)ₘ(OR²)₃₋ₙ₋ₘ, and/or the condensates thereof having one or more P—O—P bonds or a group of the formula (III) ⁻OC(═O)R^{1′}.

The invention relates to substances exhibiting phosphorus compounds which can be crosslinked by a condensation reaction, to a process for the preparation thereof and to the use thereof.

One-component sealants which are storable with the exclusion of water and which vulcanize on admission of water at ambient temperature to give elastomers are well known. These products are used in large amounts, for example in the construction industry. These mixtures are based on polymers which are terminated by silyl groups carrying reactive substituents, such as OH groups, or hydrolyzable groups, such as, for example, alkoxy groups. Usually, such substances comprise curing catalysts, such as tin compounds with amines and optionally acids of phosphorus; titanates or zirconates. Zinc, bismuth and vanadium compounds are furthermore also mentioned. All these catalysts have certain disadvantages. Thus, the labeling requirements of dibutyltin compounds are becoming markedly tighter, which is generally increasing the demand for a replacement of tin compounds. The other known alternatives often have a tendency towards yellowing, which interferes with the preparation of transparent colorless substances. Furthermore, the stability on storage of substances with other metals is frequently unsatisfactory.

A subject matter of the invention is substances which can be crosslinked by a condensation reaction and which comprise an organic polymer with at least one organyloxysilyl radical (A) and

compounds (B) of the formula

[R₄P⁺]ₛX^{s-} (I)

in which
s is 1, 2 or 3,
R can be identical or different and are optionally substituted hydrocarbon radicals with from 1 to 40 carbon atoms,
X is a group of the formula

O═PR¹ₙ(O⁻)ₘ(OR²)₃₋ₙ₋ₘ (II)

and/or the condensates thereof with one or more P—O—P bonds or a group of the formula

⁻OC(═O)R^{1′} (III)

in which
R¹ can be identical or different and are optionally substituted hydrocarbon radicals which can be interrupted by oxygen atoms,
R^{1′} can be identical or different and are optionally substituted hydrocarbon radicals which can be interrupted by oxygen atoms,
n is 0, 1 or 2,
m is 1, 2 or 3 and
m+n is 1, 2 or 3,
R² can be identical or different and are hydrogen atoms or optionally substituted hydrocarbon radicals which can be interrupted by oxygen atoms.

Examples of R are alkyl radicals, such as the methyl, ethyl, n-propyl, isopropyl, 1-n-butyl, 2-n-butyl, isobutyl, tert-butyl, n-pentyl, isopentyl, neopentyl or tert-pentyl radicals; hexyl radicals, such as the n-hexyl radical; heptyl radicals, such as the n-heptyl radical; octyl radicals, such as the n-octyl radical and isooctyl radicals, such as the 2,2,4-trimethylpentyl radical; nonyl radicals, such as the n-nonyl radical; decyl radicals, such the n-decyl radical; dodecyl radicals, such as the n-dodecyl radical; octadecyl radicals, such as the n-octadecyl radical; cycloalkyl radicals, such as the cyclopentyl, cyclohexyl, cycloheptyl and methylcyclohexyl radicals; alkenyl radicals, such as the vinyl, 1-propenyl and 2-propenyl radicals; aryl radicals, such as the phenyl, naphthyl, anthryl and phenanthryl radicals; alkaryl radicals, such as o-, m- and p-tolyl radicals, xylyl radicals and ethylphenyl radicals; and aralkyl radicals, such as the benzyl radical, the α-phenylethyl radical and the β-phenylethyl radical.

Examples of halogenated radicals R are haloalkyl radicals, such as the 3,3,3-trifluoro-n-propyl radical, the 2,2,2,2′,2′,2′-hexafluoroisopropyl radical or the heptafluoroisopropyl radical, and haloaryl radicals, such as the o-, m- and p-chlorophenyl radical.

R radicals are preferably optionally substituted hydrocarbon radicals with from 1 to 20 carbon atoms, particularly preferably hydrocarbon radicals with from 1 to 16 carbon atoms, in particular hydrocarbon radicals with from 1 to 8 carbon atoms.

Examples of radicals R¹ are the examples of hydrocarbon radicals given for the radicals R which can be substituted with halogen atoms, amino groups, ether groups, ester groups, epoxy groups, mercapto groups, cyano groups, (poly)glycol radicals or —C(O)O⁻, —P(O)(R′)O⁻, —P(O)(OR′)O⁻, —C(O)OH, —C(O)OR′, —P(O)(R′)OH or —P(O)(OR′)OH groups and/or which can be interrupted by oxygen atoms, it being possible for R′ each time to be identical or different and R′ having a meaning given for R.

Examples of radicals R^{1′} are the examples of hydrocarbon radicals given for the radicals R which can be substituted with halogen atoms, amino groups, ether groups, ester groups, epoxy groups, mercapto groups, cyano groups, (poly)glycol radicals or —C(O)O⁻, —P(O)(R′)O⁻, —P(O)(OR′)O⁻, —C(O)OH, —C(O)OR′, —P(O)(R′)OH or —P(O)(OR′)OH groups and/or which can be interrupted by oxygen atoms, it being possible for R′ each time to be identical or different and R′ having a meaning given for R, such as, for example, 4-carboxylic acid cyclohexyl, cyclohexyl-4-carbonate, O-ethyl-cyclohexyl-4-carbonate, 11-carboxylic acid undecyl, 11-undecanoate, O-isooctyl-11-undecanoate, lauryl diethylene glycolate methyl, 4-nonylphenyl pentaethylene glycolate methyl, oleyl ether hexaethylene glycolate methyl or 4-(tert-butyl)phenyl ether oligoethylene glycolate methyl radical.

Radicals R¹ are preferably hydrocarbon radicals with from 1 to 50 carbon atoms which are optionally substituted with halogen atoms, amino groups, ether groups, ester groups, epoxy groups, mercapto groups, cyano groups, poly(glycol) radicals or —C(O)O⁻, —P(O)(R′)O⁻, —P(O)(OR′)O⁻, —C(O)OH, —C(O)OR′, —P(O)(R′)OH or —P(O)(OR′)OH groups and which can be interrupted by oxygen atoms, particularly preferably hydrocarbon radicals with from 1 to 30 carbon atoms, in particular hydrocarbon radicals with from 1 to 20 carbon atoms, it being possible for R′ each time to be identical or different and R′ having a meaning given for R.

Radicals R^{1′} are preferably hydrocarbon radicals with from 1 to 50 carbon atoms which are optionally substituted with halogen atoms, amino groups, ether groups, ester groups, epoxy groups, mercapto groups, cyano groups, (poly)glycol radicals or —C(O)O⁻, —P(O)(R′)O⁻, —P(O)(OR′)O⁻, —C(O)OH, —C(O)OR′, —P(O)(R′)OH or —P(O)(OR′)OH groups and which can be interrupted by oxygen atoms, particularly preferably hydrocarbon radicals with from 3 to 50 carbon atoms which can be interrupted by oxygen atoms and/or which can be substituted with the —C(O)OR′, —C(O)O⁻ or —C(O)OH group, in particular hydrocarbon radicals with from 3 to 20 carbon atoms which can be interrupted by oxygen atoms and/or which can be substituted with the —C(O)OR′, —C(O)O⁻ or —C(O)OH group, it being possible for R′ each time to be identical or different and R′ having a meaning given for R.

Examples of radicals R² are the examples given for the radicals R and also the lauryl diethylene glycolate ethyl, 4-nonylphenyl pentaethylene glycolate ethyl, oleyl ether hexaethylene glycolate ethyl or 4-(tert-butyl)phenyl ether oligoethylene glycolate ethyl radical.

Radicals R² are preferably hydrogen atoms and optionally substituted hydrocarbon radicals with from 1 to 50 carbon atoms which can be interrupted by oxygen atoms, particularly preferably hydrogen atoms, hydrocarbon radicals with from 2 to 20 carbon atoms or hydrocarbon radicals with from 1 to 40 carbon atoms which are interrupted by oxygen atoms, in particular hydrogen atoms or hydrocarbon radicals with from 4 to 16 carbon atoms.

Preferably, s is 1 or 2 and, particularly preferably, s is 1.

Anions X are preferably acylate groups with from 4 to 31 carbon atoms, phosphate groups with from 4 to 30 carbon atoms, hydrogen phosphate groups with from 2 to 15 carbon atoms, phosphonate groups with from 2 to 15 carbon atoms, hydrogen phosphonate groups with from 2 to 15 carbon atoms or phosphinate groups with from 4 to 30 carbon atoms.

Anions X are particularly preferably acylate groups with from 6 to 25 carbon atoms, phosphate groups with from 6 to 20 carbon atoms, hydrogen phosphate groups with from 4 to 10 carbon atoms, phosphonate groups with from 2 to 12 carbon atoms, hydrogen phosphonate groups with from 2 to 12 carbon atoms and phosphinate groups with from 6 to 24 carbon atoms.

Anions X are in particular acylate groups with from 6 to 25 carbon atoms, phosphonate groups with from 2 to 10 carbon atoms, hydrogen phosphonate groups with from 2 to 10 carbon atoms or phosphinate groups with from 8 to 20 carbon atoms.

Anions X are very particularly preferably acylate groups or phosphinate groups.

Examples of compound (B) are

tetra(n-butyl)phosphonium bis(2,4,4-trimethylpentyl)phosphinate,
tri(n-butyl)methylphosphonium bis(2,4,4-trimethylpentyl)phosphinate,
tri(n-hexyl)tetradecylphosphonium bis(2,4,4-trimethylpentyl)phosphinate,
tetra(n-butyl)phosphonium hydrogen octylphosphonate,
bis[tetra(n-butyl)phosphonium]octylphosphonate,
tetra(n-butyl)phosphonium hydrogen vinylphosphonate,
bis[tetra(n-butyl)phosphonium]vinylphosphonate,
tetra(n-butyl)phosphonium hydrogen laurylphosphonate,
bis[tetra(n-butyl)phosphonium]laurylphosphonate,
tri(n-butyl)methylphosphonium hydrogen octylphosphonate,
bis[tri(n-butyl)methylphosphonium]octylphosphonate,
tri(n-hexyl)(n-tetradecyl)phosphonium hydrogen octylphosphonate,
bis[tri(n-hexyl)(n-tetradecyl)phosphonium]octylphosphonate,
tetra(n-butyl)phosphonium bis(2-ethylhexyl)phosphate,
tetra(n-butyl)phosphonium dioctyl phosphate,
tri(n-butyl)methylphosphonium dibutyl phosphate,
triethylmethylphosphonium dibutyl phosphate,
tetraphenylphosphonium dibutyl phosphate,
tetra(n-butyl)phosphonium di(ethyl ethoxylate lauryl ether) phosphate,
di(n-butyl)dimethylphosphonium dimethyl phosphate,
dicyclohexyldimethylphosphonium dimethyl phosphate,
diisobutyldimethylphosphonium dimethyl phosphate,
tri(n-butyl)methylphosphonium bis(2-ethylhexyl)phosphate,
tri(n-hexyl)(n-tetradecyl)phosphonium dioctyl phosphate,
tetra(n-butyl)phosphonium octyl hydrogen phosphate,
bis[tetra(n-butyl)phosphonium]octyl phosphate,
tetra(n-butyl)phosphonium 2-ethylhexyl hydrogen phosphate,
bis[tetra(n-butyl)phosphonium]2-ethylhexyl phosphate,
tetra(n-butyl)phosphonium butyl hydrogen phosphate,
bis[tetra(n-butyl)phosphonium]butyl phosphate,
tetra(n-butyl)phosphonium lauryl hydrogen phosphate,
bis[tetra(n-butyl)phosphonium]lauryl phosphate,
tri(n-butyl)methylphosphonium octyl hydrogen phosphate,
bis[tri(n-butyl)methylphosphonium]octyl phosphate,
tri(n-hexyl)tetradecylphosphonium octyl hydrogen phosphate,
bis[tri(n-hexyl)tetradecylphosphonium]octyl phosphate,
tetra(n-butyl)phosphonium n-octoate,
tetra(n-butyl)phosphonium 2-ethylhexanoate,
tetra(n-butyl)phosphonium neodecanoate,
tetra(n-butyl)phosphonium monomethyl adipate,
tetra(n-butyl)phosphonium monoisobutyl succinate,
triphenylvinylphosphonium neodecanoate,
tetraphenylphosphonium neodecanoate,
tetra(n-butyl)phosphonium acetate,
tetra(n-butyl)phosphonium glycolate ethoxylate lauryl ether,
bis[tetra(n-butyl)phosphonium]cyclohexyldicarbonate,
tetra(n-butyl)phosphonium hydrogen cyclohexylcarbonate,
bis[tetra(n-butyl)phosphonium]dodecanedioate,
tetra(n-butyl)phosphonium hydrogen dodecaneoate,
tri(n-butyl)methylphosphonium n-octoate,
tetramethylphosphonium n-octoate,
triethylmethylphosphonium n-octoate,
tri(n-butyl)methylphosphonium n-octoate,
tri(n-hexyl)(n-tetradecyl)phosphonium n-octoate and
tri(n-hexyl)(n-tetradecyl)phosphonium decanoate.

Compound (B) is preferably
tetra(n-butyl)phosphonium bis(2,4,4-trimethylpentyl)phosphinate,
tri(n-butyl)methylphosphonium bis(2,4,4-trimethylpentyl)phosphinate,
tetra(n-butyl)phosphonium hydrogen octylphosphonate,
bis[tetra(n-butyl)phosphonium]octylphosphonate,
tetra(n-butyl)phosphonium hydrogen vinylphosphonate,
bis[tetra(n-butyl)phosphonium]vinylphosphonate,
tetra(n-butyl)phosphonium hydrogen laurylphosphonate,
bis[tetra(n-butyl)phosphonium]laurylphosphonate,
tri(n-butyl)methylphosphonium hydrogen octylphosphonate,
bis[tri(n-butyl)methylphosphonium]octylphosphonate,
tetra(n-butyl)phosphonium bis(2-ethylhexyl)phosphate,
tetra(n-butyl)phosphonium dioctyl phosphate,
tri(n-butyl)methylphosphonium dibutyl phosphate,
triethylmethylphosphonium dibutyl phosphate,
tri(n-butyl)methylphosphonium bis(2-ethylhexyl)phosphate,
tetra(n-butyl)phosphonium octyl hydrogen phosphate,
bis[tetra(n-butyl)phosphonium]octyl phosphate,
tetra(n-butyl)phosphonium 2-ethylhexyl hydrogen phosphate,
bis[tetra(n-butyl)phosphonium]2-ethylhexyl phosphate,
tetra(n-butyl)phosphonium butyl hydrogen phosphate,
bis[tetra(n-butyl)phosphonium]butyl phosphate,
tetra(n-butyl)phosphonium lauryl hydrogen phosphate,
bis[tetra(n-butyl)phosphonium]lauryl phosphate,
tri(n-butyl)methylphosphonium octyl hydrogen phosphate,
bis[tri(n-butyl)methylphosphonium]octyl phosphate,
tetra(n-butyl)phosphonium n-octoate,
tetra(n-butyl)phosphonium 2-ethylhexanoate,
tetra(n-butyl)phosphonium neodecanoate,
tetra(n-butyl)phosphonium monomethyl adipate,
tetra(n-butyl)phosphonium monoisobutyl succinate,
tetra(n-butyl)phosphonium glycolate ethoxylate lauryl ether,
bis[tetra(n-butyl)phosphonium]cyclohexyldicarbonate,
tetra(n-butyl)phosphonium hydrogen cyclohexylcarbonate,
bis[tetra(n-butyl)phosphonium]dodecanedioate,
tetra(n-butyl)phosphonium hydrogen dodecaneoate,
tri(n-butyl)methylphosphonium n-octoate,
tetramethylphosphonium n-octoate,
triethylmethylphosphonium n-octoate and
tri(n-butyl)methylphosphonium n-octoate,
   particularly preferably
tetra(n-butyl)phosphonium bis(2,4,4-trimethylpentyl)phosphinate,
tri(n-butyl)methylphosphonium bis(2,4,4-trimethylpentyl)phosphinate,
tetra(n-butyl)phosphonium hydrogen octylphosphonate,
bis[tetra(n-butyl)phosphonium]octylphosphonate,
tri(n-butyl)methylphosphonium hydrogen octylphosphonate,
bis[tri(n-butyl)methylphosphonium]octylphosphonate,
tetra(n-butyl)phosphonium bis(2-ethylhexyl)phosphate,
tetra(n-butyl)phosphonium dioctyl phosphate,
tri(n-butyl)methylphosphonium dibutyl phosphate,
triethylmethylphosphonium dibutyl phosphate,
tri(n-butyl)methylphosphonium bis(2-ethylhexyl)phosphate,
tetra(n-butyl)phosphonium octyl hydrogen phosphate,
bis[tetra(n-butyl)phosphonium]octyl phosphate,
tetra(n-butyl)phosphonium 2-ethylhexyl hydrogen phosphate,
bis[tetra(n-butyl)phosphonium]2-ethylhexyl phosphate,
tetra(n-butyl)phosphonium butyl hydrogen phosphate,
bis[tetra(n-butyl)phosphonium]butyl phosphate,
tetra(n-butyl)phosphonium lauryl hydrogen phosphate,
bis[tetra(n-butyl)phosphonium]lauryl phosphate,
tri(n-butyl)methylphosphonium octyl hydrogen phosphate,
bis[tri(n-butyl)methylphosphonium]octyl phosphate,
tetra(n-butyl)phosphonium n-octoate,
tetra(n-butyl)phosphonium 2-ethylhexanoate,
tetra(n-butyl)phosphonium neodecanoate,
tetra(n-butyl)phosphonium glycolate ethoxylate lauryl ether,
bis[tetra(n-butyl)phosphonium]cyclohexyldicarbonate,
tetra(n-butyl)phosphonium hydrogen cyclohexylcarbonate,
bis[tetra(n-butyl)phosphonium]dodecanedioate,
tetra(n-butyl)phosphonium hydrogen dodecaneoate,
tri(n-butyl)methylphosphonium n-octoate,
tetramethylphosphonium n-octoate,
triethylmethylphosphonium n-octoate and
tri(n-butyl)methylphosphonium n-octoate,
   in particular
tetra(n-butyl)phosphonium bis(2,4,4-trimethylpentyl)phosphinate,
tri(n-butyl)methylphosphonium bis(2,4,4-trimethylpentyl)phosphinate,
tetra(n-butyl)phosphonium n-octoate,
tetra(n-butyl)phosphonium 2-ethylhexanoate,
tetra(n-butyl)phosphonium neodecanoate,
tetra(n-butyl)phosphonium glycolate ethoxylate lauryl ether,
tri(n-butyl)methylphosphonium n-octoate,
tetramethylphosphonium n-octoate,
triethylmethylphosphonium n-octoate and
tri(n-butyl)methylphosphonium n-octoate.

The components (B) used according to the invention are commercial products or can be prepared according to methods standard in the field of chemistry.

Organic polymers (A) within the meaning of the present invention are to be understood as all polymers in which at least 50%, preferably at least 70%, particularly preferably at least 90%, of all bonds in the main chain are carbon-carbon, carbon-nitrogen or carbon-oxygen bonds.

The substances according to the invention comprise component (B) in amounts of preferably from 0.005 to 5 parts by weight, particularly preferably from 0.01 to 3 parts by weight, in particular from 0.05 to 2 parts by weight, in each case based on 100 parts by weight of component (A).

In addition to the components (A) and (B), the substances according to the invention can now comprise all substances which have also been used hitherto in substances which can be crosslinked by a condensation reaction.

The substances according to the invention are preferably those comprising

(A) an organic polymer exhibiting at least one group of the formula

—SiR³ₐ(OR⁴)₃₋ₐ (IV)

in which
R³ can be identical or different and are optionally substituted hydrocarbon radicals which can be interrupted by oxygen atoms,
R⁴ can be identical or different and are hydrogen atoms or optionally substituted hydrocarbon radicals and
a is 0, 1 or 2,
(B) compound of the formula (I),
if appropriate
(C) crosslinking agents,
if appropriate
(D) plasticizers,
if appropriate
(E) fillers,
if appropriate
(F) bonding agents and
if appropriate
(G) additives.

Radicals R³ are preferably monovalent hydrocarbon radicals with from 1 to 18 carbon atoms which are optionally substituted with halogen atoms, amino groups, ether groups, ester groups, epoxy groups, mercapto groups, cyano groups or (poly)glycol radicals, the latter being formed from oxyethylene and/or oxypropylene units, particularly preferably alkyl radicals with from 1 to 12 carbon atoms, in particular the methyl radical. Radicals R³ can also, however, be divalent radicals which, e.g., combine together two silyl groups.

Examples of radicals R³ are the examples given for radicals R.

Examples of radicals R⁴ are the radicals given for R.

Radicals R⁴ are preferably hydrogen atoms or alkyl radicals with from 1 to 12 carbon atoms, particularly preferably hydrogen atoms or alkyl radicals with from 1 to 4 carbon atoms, in particular hydrogen atoms or the methyl and ethyl radicals.

Examples of component (A) are organic polymers exhibiting organyloxysilyl groups, such as polyacrylates, vinyl polymers, polyurethanes and polyglycols, which can be linear or branched. These polymers can be prepared by known processes, such as addition reactions, such as, e.g., hydrosilylation, Michael addition, Diels-Alder addition, the addition of isocyanate to reactive groups exhibiting active hydrogen, such as amines, amides, hydroxyl groups or mercapto groups, and also the addition of amines to epoxides or the copolymerization of vinylsilanes with organic monomers exhibiting a double bond or the grafting of vinylsilanes to vinyl polymers. The preparation methods can, if appropriate, be combined with one another.

However, copolymers of siloxane blocks and organic polymers can also be used as component (A), such as, e.g., described in EP-B1 1 370 602, which is to be regarded as part of the disclosure content of the present application.

The polymers (A) used according to the invention can be both homopolymers and copolymers, which can each be linear or branched.

Preferably, component (A) exhibits at least two groups of the formula (IV). The component (A) can exhibit the organyloxysilyl groups at any points on the polymer, such as, for example, in the chain and/or at the chain end. Furthermore, the organyloxysilyl groups can also be bonded to the organic polymer via one or more diorganosiloxy groups.

Component (A) preferably relates to organic polymers exhibiting organyloxysilyl groups which comprise, as polymer chain, polyoxyalkylenes, such as polyoxyethylene, polyoxypropylene, polyoxybutylene, polyoxytetramethylene, polyoxyethylene/polyoxypropylene copolymer and polyoxypropylene/polyoxybutylene copolymer; hydrocarbon polymers, such as polyisobutylene and copolymers of isobutylene with isoprene; polychloroprenes; polyisoprenes; polyurethanes; polyesters; polyamides; polyacrylates; polymethacrylates; vinyl polymers and polycarbonates.

Component (A) relates particularly preferably to polyoxyalkylenes and polyacrylates, in particular to polyoxyalkylenes.

If the component (A) used according to the invention relates to polyoxyalkylenes (A1), these preferably comprise repeat units of the formula

—R⁷—O— (V),

in which
R⁷ can be identical or different and are an optionally substituted divalent hydrocarbon radical with from 1 to 12 carbon atoms which can be linear or branched.

The polyoxyalkylenes (A1) used according to the invention preferably comprise at least 50%, particularly preferably at least 70%, of repeat units of the formula (V), in each case based on the total number of the repeat units.

In addition to the repeat units of the formula (V), the polyoxyalkylenes (A1) used according to the invention can comprise yet additional units, such as, e.g., amide, urea, urethane, thiourethane, alkylene, arylene, ester, carbonate, imide or imine units.

Radicals R⁷ preferably relate to an optionally substituted divalent hydrocarbon radical with from 1 to 4 carbon atoms, particularly preferably to a divalent hydrocarbon radical with from 1 to 4 carbon atoms, in particular the propylene radical.

Examples of radicals R⁷ are —CH₂—, —CH₂—CH₂—, —CH₂—CH(CH₃)—, —CH₂—CH₂—CH₂—, —CH₂—CH(—CH₂—CH₃)—, —CH(CH₃)—CH(CH₃)—, —CH₂—CH₂—CH₂—CH₂— and —CH₂—C(CH₃)₂—, —CH₂—CH₂— and —CH₂—CH(CH₃)— being particularly preferred, in particular —CH₂—CH(CH₃)—.

If the organic polymers (A) used according to the invention are polyacrylates (A2), these preferably comprise repeat units of the formula

—CH₂—C(R⁸)(COOR⁹)— (VI),

in which
R⁸ can be identical or different and are hydrogen atoms or methyl radicals and
R⁹ can be identical or different and are optionally substituted monovalent hydrocarbon radicals.

The polyacrylates (A2) used according to the invention preferably comprise at least 50%, particularly preferably at least 70%, of repeat units of the formula (VI), in each case based on the total number of the repeat units.

In addition to the repeat units of the formula (VI), the polyacrylates (A2) used according to the invention can comprise yet additional groups, such as, e.g., styrene units, perfluoroethylene units, maleic acid units or the monoester or diester units thereof or derivatives thereof, such as maleimides, fumaric acid units or the monoester or diester units thereof, nitrile units, vinyl ester units, such as vinyl acetate or vinyl laurate units, alkane units, such as ethylene, propylene or octylene units, conjugated diene units, such as butadiene or isoprene units, vinyl chloride units, vinylene chloride units, allyl chloride units or allyl alcohol units. Following the usage standard in polymer chemistry, these units are in some cases named after the monomers used in the polymerization process, which is well known to a person skilled in the art.

Radicals R⁹ are preferably optionally substituted hydrocarbon radicals with from 1 to 30 carbon atoms, particularly preferably with from 1 to 20 carbon atoms.

Examples of the repeat unit according to formula (VI) are: —CH₂—C(CH₃)(COOCH₃)—, —CH₂—C(CH₃)(COOCH₂CH₃)—, —CH₂—C(CH₃)(COOCH₂CH₂CH₃)—, —CH₂—C(CH₃)(COOCH₂CH₂CH₂CH₃)—, —CH₂—C(CH₃)(COOCH(CH₃)₂)—, —CH₂—C(H)(COOCH₂CH(CH₃)₂)—, —CH₂—C(H)(COOC(CH₃)₃)—, —CH₂—C(CH₃)(COO(CH₂)₄CH₃)—, —CH₂—C(CH₃)(COO(CH₂)₅CH₃)—, —CH₂—C(CH₃)(COO-cyclohexyl)-, —CH₂—C(CH₃)(COO(CH₂)₆CH₃)—, —CH₂—C(CH₃)(COO(CH₂)₇CH₃)—, —CH₂—C(CH₃)(COOCH₂CH(CH₂CH₃) CH₂CH₂CH₂CH₃)—, —CH₂—C(CH₃)(COOCH₂CH(CH₃) CH₂C(CH₃)₃)—, —CH₂—C(CH₃)(COO(CH₂)₈CH₃)—, —CH₂—C(CH₃)(COO(CH₂)₉CH₃)—, —CH₂—C(CH₃)(COO(CH₂)₁₁CH₃)—, —CH₂—C(CH₃)(COO(CH₂)₁₃CH₃)—, —CH₂—C(CH₃)(COO(CH₂)₁₅CH₃)—, —CH₂—C(CH₃)(COO(CH₂)₁₇CH₃)—, —CH₂—C(CH₃)(COOPh)-, —CH₂—C(CH₃)(COOCH₂Ph)-, —CH₂—C(CH₃)(COOCH₂CH₂OCH₃)—, —CH₂—C(CH₃)(COOCH₂CH₂OH)—, —CH₂—C(CH₃)(COOCH₂CH₂CH(OCH₃) CH₃)—, —CH₂—C(CH₃)(COOCH₂CH(OH)CH₃)—, —CH₂—C(CH₃)(COO-glycidyl)-, —CH₂—C(CH₃)(COO—CH₂CH₂CH₂Si (OCH₃)₃)—, —CH₂—C(CH₃)(COO—CH₂CH₂CH₂Si (OCH₃)₂CH₃)—, —CH₂—C(CH₃)(COO—(CH₂CH₂O)ₓH)—, —CH₂—C(CH₃)(COOCH₃)—, —CH₂—C(CH₃)(COOCH₂CH₂CF₃)— and —CH₂—C(CH₃)(COOCH₂CH₂CF₂CF₃)—; and also —CH₂—C(H)(COOCH₃)—, —CH₂—C(H)(COOCH₂CH₃)—, —CH₂—C(H)(COOCH₂CH₂CH₃)—, —CH₂—C(H)(COOCH₂CH₂CH₂CH₃)—, —CH₂—C(H)(COOCH(CH₃)₂)—, —CH₂—C(H)(COOCH₂CH(CH₃)₂)—, —CH₂—C(H)(COOC(CH₃)₃)—, —CH₂—C(H)(COO(CH₂)₄—CH₃)—, —CH₂—C(H)(COO(CH₂)₅CH₃)—, —CH₂—C(CH₃)(COOCH₂CH₂OCH₃)—, —CH₂—C(CH₃)(COOCH₂CH₂OCH₂CH₃)—, —CH₂—C(CH₃)(COOCH₂CH₂CH(OCH₃) CH₃)— and —CH₂—C(H)(COOCH₂CH(CH₂CH₃) CH₂CH₂CH₂CH₃)—.

Particular preference is given to the repeat units —CH₂—C(CH₃)(COOCH₃)—, —CH₂—C(CH₃)(COOCH₂CH₃)—, —CH₂—C(CH₃)(COOCH₂CH₂CH₃)—, —CH₂—C(CH₃)(COOCH₂CH₂CH₂CH₃)—, —CH₂—C(CH₃)(COOCH(CH₃)₂)—, —CH₂—C(H)(COOCH₂CH(CH₃)₂)—, —CH₂—C(H)(COOC(CH₃)₃)—, —CH₂—C(CH₃)(COO(CH₂)₄—CH₃)—, —CH₂—C(CH₃)(COO(CH₂)₅CH₃)—, —CH₂—C(CH₃)(COO-cyclohexyl)-, —CH₂—C(CH₃)(COOC(CH₂)₆CH₃)—, —CH₂—C(CH₃)(COO(CH₂)₇CH₃)—, —CH₂—C(CH₃)(COOCH₂CH(CH₂CH₃) CH₂CH₂CH₂CH₃)—, —CH₂—C(CH₃)(COOCH₂CH(CH₃) CH₂C(CH₃)₃)—, —CH₂—C(CH₃)(COO(CH₂)₈CH₃)—, —CH₂—C(CH₃)(COO(CH₂)₉CH₃)—, —CH₂—C(CH₃)(COO(CH₂)₁₁CH₃)—, —CH₂—C(CH₃)(COO(CH₂)₁₃CH₃)—, —CH₂—C(CH₃)(COO(CH₂)₁₅CH₃)—, —CH₂—C(CH₃)(COO(CH₂)₁₇CH₃)—, —CH₂—C(CH₃)(COOCH₂CH₂OCH₃)— and —CH₂—C(CH₃)(COOCH₂CH₂CH(OCH₃) CH₃)—; and also —CH₂—C(H)(COOCH₃)—, —CH₂—C(H)(COOCH₂CH₃)—, —CH₂—C(H)(COOCH₂CH₂CH₃)—, —CH₂—C(H)(COOCH₂CH₂CH₂CH₃)—, —CH₂—C(H)(COOCH(CH₃)₂)—, —CH₂—C(H)(COOCH₂CH(CH₃)₂)—, —CH₂—C(H)(COOC(CH₃)₃)—, —CH₂—C(H)(COO(CH₂)₄—CH₃)—, —CH₂—C(H)(COO(CH₂)₅CH₃)—, —CH₂—C(CH₃)(COOCH₂CH₂OCH₃)—, —CH₂—C(CH₃)(COOCH₂CH₂OCH₂CH₃)—, —CH₂—C(CH₃)(COOCH₂CH₂CH(OCH₃) CH₃)— and —CH₂—C(H)(COOCH₂CH(CH₂CH₃)CH₂CH₂CH₂CH₃)—.

The polymers (A), particularly preferably the polyoxyalkylenes (A1), used according to the invention preferably comprise units of the formula

—NR¹⁰—C(═O)— (VII),

in which
R¹⁰ can be identical or different and are hydrogen atoms or optionally substituted monovalent hydrocarbon radicals.

Radicals R¹⁰ are preferably hydrogen atoms or optionally substituted hydrocarbon radicals with from 1 to 12 carbon atoms, particularly preferably hydrogen atoms or hydrocarbon radicals with from 1 to 6 carbon atoms.

Component (A) has a viscosity of preferably from 100 to 1 000 000 mPa·s, particularly preferably from 1000 to 350 000 mPa·s, in each case at 25° C.

Organic polymers (A) are commercial products or can be prepared according to methods standard in the field of chemistry.

The crosslinking agents (C) optionally used in the substances according to the invention can be any crosslinking agent known hitherto with at least two condensable radicals, such as, for example, silanes or siloxanes with at least two organyloxy groups.

The crosslinking agents (C) optionally used in the substances according to the invention are preferably organosilicon compounds of the formula

(R⁵O)_{b}SiR⁶_{(4-b)} (VIII),

in which
R⁵ can be identical or different and are hydrogen atoms or optionally substituted monovalent hydrocarbon radicals,
R⁶ can be identical or different and are optionally substituted monovalent hydrocarbon radicals which can be interrupted by oxygen atoms and
b is 2, 3 or 4,
and also the partial hydrolysates thereof.

In this connection, the partial hydrolysates can be partial homohydrolysates, i.e. partial hydrolysates of one type of organosilicon compound of the formula (VIII), and also partial cohydrolysates, i.e. partial hydrolysates of at least two different types of organosilicon compounds of the formula (VIII).

If the crosslinking agents (C) optionally used in the substances according to the invention relate to partial hydrolysates of organosilicon compounds of the formula (VIII), those with up to 6 silicon atoms are preferred.

Examples of radicals R⁵ are the examples mentioned above for the radical R⁴.

Due to contact with atmospheric moisture during the preparation and storage of the organosilicon compounds of the formula (VIII), which is frequently unavoidable in practice, silanol groups may be produced and thus R⁵ is then a hydrogen atom. These silanol groups are generally not deliberately prepared but will in practice be generally detectable.

Radicals R⁵ are preferably alkyl radicals with from 1 to 12 carbon atoms, particularly preferably alkyl radicals with from 1 to 4 carbon atoms, in particular the methyl and ethyl radicals.

Examples of radicals R⁶ are the monovalent examples mentioned above for the radical R³, optionally substituted hydrocarbon radicals with from 1 to 12 carbon atoms being preferred and the methyl, N-cyclohexylaminomethyl, O-methyl-N-carbamatomethyl and vinyl radicals being particularly preferred.

The crosslinking agents (C) optionally used in the substances according to the invention are particularly preferably tetramethoxysilane, tetraethoxysilane, tetrapropoxysilane, tetrabutoxysilane, methyltrimethoxysilane, methyltriethoxysilane, vinyltrimethoxysilane, vinyltriethoxysilane, phenyltrimethoxysilane, phenyltriethoxysilane, 3-cyanopropyltrimethoxysilane, 3-cyanopropyltriethoxysilane, 3-(glycidoxy)-propyltriethoxysilane, 1,2-bis(trimethoxysilyl)ethane, 1,2-bis(triethoxysilyl)ethane, (N-cyclohexylaminomethyl)methyldiethoxysilane, (N-cyclohexylaminomethyl)triethoxysilane, (N-phenylaminomethyl)methyldimethoxysilane, (methacryloyloxymethyl)methyldimethoxysilane, (methacryloyloxymethyl)methyldiethoxysilane, N-(trimethoxysilylmethyl)-O-methylcarbamate, methyltris(methylethylketoximo)silane, vinyltris(methylethylketoximo)silane, tetrakis(methylethylketoximo)silane and also partial hydrolysates of the organosilicon compounds mentioned, such as, e.g., hexamethoxydisiloxane, octamethoxytrisiloxane or hexaethoxydisiloxane.

The crosslinking agents (C) optionally used in the substances according to the invention are commercial products or can be prepared according to processes known in the field of silicon chemistry.

If the substances according to the invention comprise crosslinking agent (C), the amounts concerned are from preferably 0.01 to 20 parts by weight, particularly preferably from 0.5 to 10 parts by weight, in particular from 1.0 to 5.0 parts by weight, in each case based on 100 parts by weight of constituent (A).

Examples of plasticizers (D) are dimethylpolysiloxanes end-blocked by trimethylsiloxy groups which are liquid at ambient temperature, in particular with viscosities at 25° C. in the range between 50 and 1000 mPa·s, and also high boiling point hydrocarbons, such as, for example, paraffin oils, dialkylbenzenes, dialkylnaphthalenes or mineral oils consisting of naphthene and paraffin units, polyglycols, in particular polypropylene glycols, which can optionally be substituted, high boiling point esters, such as, e.g., phthalates, citrates or dicarboxylates, liquid polyesters, polyacrylates or polymethacrylates, and also alkylsulfonates.

The substances according to the invention comprise plasticizers (D) in amounts from preferably 0 to 300 parts by weight, particularly preferably from 10 to 200 parts by weight, in particular from 20 to 100 parts by weight, in each case based on 100 parts by weight of constituent (A).

Examples of fillers (E) are nonreinforcing fillers, thus fillers with a BET surface of up to 50 m²/g, such as quartz, diatomaceous earth, calcium silicate, zirconium silicate, zeolites, metal oxide powders, such as aluminum, titanium, iron or zinc oxides or the mixed oxides thereof, barium sulfate, calcium carbonate, gypsum, silicon nitride, silicon carbide, boron nitride, glass and plastic powders, such as polyacrylonitrile powder; reinforcing fillers, thus fillers with a BET surface of more than 50 m²/g, such as pyrogenic silica, precipitated silica, precipitated calcium carbonate, carbon black, such as furnace black and acetylene black, and silicon/aluminum mixed oxides with a large BET surface; fibrous fillers, such as asbestos, and also plastic fibers. The fillers mentioned can be rendered hydrophobic, for example by treatment with organosilanes or organosiloxanes or with stearic acid or by etherification of hydroxyl groups to give alkoxy groups. If fillers (E) are used, they are preferably hydrophobic pyrogenic silica and precipitated or ground calcium carbonate.

The substances according to the invention comprise fillers (E) in amounts from preferably 0 to 300 parts by weight, particularly preferably from 1 to 200 parts by weight, in particular from 5 to 200 parts by weight, in each case based on 100 parts by weight of constituent (A).

Examples of the bonding agents (F) used in the substances according to the invention are silanes and organopolysiloxanes with functional groups, such as, for example, those with glycidoxypropyl, amino or methacryloyloxypropyl radicals and also tetraalkoxysilanes and siloxanes comprising T or Q groups which can optionally exhibit alkoxy groups. If, however, another component, such as, for example, component (A) or crosslinking agent (C), already exhibits the functional groups mentioned, an addition of bonding agent may be dispensed with.

The substances according to the invention comprise bonding agents (F) in amounts from preferably 0 to 50 parts by weight, particularly preferably from 1 to 20 parts by weight, in particular from 1 to 10 parts by weight, in each case based on 100 parts by weight of constituent (A).

Examples of additives (G) are pigments, dyes, fragrances, oxidation inhibitors, such as sterically hindered phenols, e.g. 2,6-di(tert-butyl)-4-methylphenol (BHT), products obtainable under the trade names Irganox® 1076, Irganox® 1010, Irganox® 245 or Irganox® 1135 from Ciba, Switzerland, or vitamin E, fungicides, such as, e.g., isothiazolinones, in particular n-2-octyl-2H-isothiazolin-3-one, n-butyl-1,2-benzisothiazolin-3-one or 4,5-dichloro-2-octyl-3(2H)-isothiazolin-3-one, 3-iodo-2-propynyl butylcarbamate, thiabendazole, carbendazim, 3-(benzo[b]thien-2-yl)-5,6-dihydro-1,4,2-oxathiazine 4-oxide, N-cyclohexylbenzothiophene-2-carboxamide S,S-dioxide or 2-(thiazol-4-yl)-1H-benzimidazole, silver-comprising carriers or nanosilver, triazole derivatives, such as tebuconazole, or combinations of two or three active substances, agents for influencing the electrical properties, such as conductive blacks, flame retardants, light stabilizers, such as UV absorbers, e.g. benzotriazole derivatives (products obtainable under the trade name Tinuvin® P, Tinuvin® 213, Tinuvin® 234, Tinuvin® 327, Tinuvin® 328 or Tinuvin® 571 from Ciba, Switzerland, or Uvinul® 3026, Uvinul® 3027, Uvinul® 3028, Uvinul® 3029, Uvinul® 3033P or Uvinul® 3034 from BASF AG, Germany), nanometal oxides, e.g. of titanium or zinc, cyanoacrylates, e.g. Uvinul® 3030, Uvinul® 3035 or Uvinul® 3039 from BASF AG, Germany, or benzophenones, such as, e.g., Uvinul® 3008, or such as radical traps, e.g. sterically hindered amines (HALS, e.g. Tinuvin® 622, Tinuvin® 765, Tinuvin® 770 or Tinuvin® 123 from Ciba, Switzerland, or Uvinul® 4050H, Uvinul® 4077H, Uvinul® 4092H, Uvinul® 5050H, or Uvinul® 5062H from BASF AG, Germany), agents for extending the skinning time, such as silanes with an SiC-bonded mercaptoalkyl radical, cell-generating agents, e.g. azodicarbonamide, heat stabilizers, scavengers, such as Si—N-comprising silazanes or silylamides, cocatalysts, such as Lewis and Brönsted acids, e.g. sulfonic acids, organic acids, phosphoric acids, phosphonic acids and phosphonic acid monoesters, thixotropic agents, such as, for example, amide waxes, hydrogenated castor oil or polyglycols, and organic solvents, such as alkylaromatic compounds, N-methylpyrrolidone, dipropylene glycol dimethyl ether or triethyl phosphate.

The substances according to the invention comprise additives (G) in amounts from preferably 0.01 to 100 parts by weight, particularly preferably from 0.05 to 30 parts by weight, in particular from 0.1 to 10 parts by weight, in each case based on 100 parts by weight of constituent (A).

The substances according to the invention are particularly preferably those which can be prepared using

(A) organic polymers comprising at least one unit of the formula (IV),
(B) compound of the formula (I),
if appropriate
(C) crosslinking agents of the formula (VIII),
if appropriate
(D) plasticizers,
if appropriate
(E) fillers,
if appropriate
(F) bonding agents,
(G) additives chosen from the group consisting of antioxidants, UV absorbers, sterically hindered amines and cocatalysts.

The substances according to the invention in particular do not comprise further constituents in addition to the components (A) to (G).

The substances according to the invention are preferably viscous to pasty substances.

All constituents can be mixed with one another in any sequence for the preparation of the substances according to the invention. This mixing can be carried out at ambient temperature and atmospheric pressure, thus approximately from 900 to 1100 hPa. If desired, this mixing can, however, also be carried out at higher temperatures, e.g. at temperatures in the range from 35° C. to 135° C. Furthermore, it is possible, for a while or continuously, to mix under reduced pressure, such as, e.g., at from 30 to 500 hPa absolute pressure, in order to remove volatile compounds and/or air.

Individual constituents of the substances according to the invention can in each case be one type of such a constituent as well as also a mixture of at least two different types of such constituents.

The usual water content of the air is sufficient for the crosslinking of the substances according to the invention. The crosslinking of the substances according to the invention is preferably carried out at ambient temperature. It can, if desired, also be carried out at higher or lower temperatures than ambient temperature, e.g. at from −5° C. to 15° C. or at from 30° C. to 50° C. and/or by means of water concentrations exceeding the normal water content of the air.

Preferably, the crosslinking is carried out at a pressure from 100 to 1100 hPa, in particular at atmospheric pressure, thus approximately from 900 to 1100 hPa.

An additional subject matter of the present invention are molded articles prepared by crosslinking the substances according to the invention.

The substances according to the invention can be used for all purposes for which substances which are storable with the exclusion of water and which crosslink on admission of water at ambient temperature to give elastomers can be used.

The substances according to the invention are accordingly excellently suitable, for example, as sealants for joints, including vertical joints, and similar empty spaces from, e.g., to 40 mm in width, e.g. of buildings, land vehicles, watercraft and aircraft, or as adhesives or putties, e.g. in the construction of windows or in the manufacture of glass cabinets, and also, e.g., for the preparation of protective coatings or antislip coatings, or of elastomeric molded articles, and also for the insulation of electrical or electronic equipment.

The substances according to the invention have the advantage that they are easy to prepare.

The substances which can be crosslinked by condensation according to the invention have the advantage that they comprise no or only extremely small amounts of compounds comprising heavy metals and accordingly have no labeling requirements and are completely harmless toxicologically.

Furthermore, the substances according to the invention have the advantage that they do not turn yellow on storage and in the cured state and accordingly high quality transparent products can also be prepared.

The crosslinkable substances according to the invention have the advantage that they are distinguished by a very high storage stability and a high crosslinking rate.

In the examples described below, all viscosity data refer to a temperature of 25° C. Unless otherwise stated, the following examples are carried out at atmospheric pressure, thus approximately at 1000 hPa, and at ambient temperature, thus at approximately 23° C., or at a temperature which appears while mixing the reactants at ambient temperature without additional heating or cooling, and also at a relative humidity of approximately 50%. Furthermore, all data for parts and percentages, insofar as not otherwise stated, refer to the weight.

### EVALUATION OF THE CURING BEHAVIOR

### Test 1

In order to assess the curing behavior, the crosslinkable substances obtained in the examples are applied to PE films in a layer with a thickness of 2 mm and stored under standard temperature and pressure conditions (23° C. and 50% relative humidity). During the curing, the formation of a skin is tested every 5 min. First, a dry finger is carefully lowered onto the surface of the test specimen and drawn upwards. If test specimen sticks to the finger, no skin has yet formed. If test specimen no longer sticks to the finger, a skin is formed and the time is recorded. After curing for 24 hours under standard temperature and pressure conditions (23° C. and 50% relative humidity), the tack of the surface is tested. For the assessment, the dry ball of the thumb is pressed against the surface and drawn upwards. The value 1 represents barely tacky or nontacky surface (test specimen is left behind), 2 represents slightly tacky surface (test specimen is raised a little), 3 represents surface is tacky (test specimen is raised and sticks).

### Examples 1-7

A 40% aqueous solution of tetrabutylphosphonium hydroxide, known as TBP solution (commercially available from Sigma-Aldrich, Germany), and the same molar amount of the acid given in table 1 were mixed and the water was distilled off at 70 to 80° C. down to a pressure of 15-20 mbar. Subsequently, the mixture was cooled down and the product drawn off. The water contents of the products thus obtained, determined by means of Karl-Fischer titration, were in each case less than 1.0%. The phosphorus compounds prepared are combined in table 1.

TABLE 1

| | Amount | | | |
|---|---|---|---|---|
| | of TBP | | Amount of | Product |
| Name of the product | solution [g] | Acid | acid [g] | appearance |
| Tetra(n-butyl)phosphonium | 69 | n-Octylphosphonic | 19.4 | Solid* |
| hydrogen n-octyl- | | acid | | |
| phosphonate (P1) | | | | |
| Tetra(n-butyl)phosphonium | 6.9 | Dodecane-1,10- | 2.30 | Colorless |
| hydrogen dodecaneoate | | dicarboxylic acid | | oil |
| (P2) | | | | |
| Tetra(n-butyl)phosphonium | 69 | Bis(2-ethylhexyl) | 32.2 | Yellowish |
| bis(2-ethylhexyl) | | phosphate | | oil |
| phosphate (P3) | | | | |
| Tetra(n-butyl)phosphonium | 69 | Bis(2,4,4-tri- | 29.0 | Yellowish |
| bis(2,4,4-trimethyl- | | methylpentyl)- | | liquid |
| pentyl)phosphinate (P4) | | phosphinic acid | | |
| Tetra(n-butyl)phosphonium | 6.9 | Glycolic acid | 4.60 | Colorless |
| glycolate ethoxylate | | ethoxylate | | liquid |
| lauryl ether (P5) | | laurate, | | |
| | | Mₙ~460 g/mol | | |
| Tetra(n-butyl)phosphonium | 69 | Neodecanoic acid | 17.2 | Colorless |
| neodecanoate (P6) | | | | liquid |
| Tetra(n-butyl)phosphonium | 69 | n-Octanoic acid | 14.4 | Colorless |
| n-octoate (P7) | | | | liquid |

*20% clear colorless solution in methyltrimethoxysilane was subsequently used.

444 g of a linear polypropylene glycol terminated by dimethoxy-silyl groups at both ends (commercially available under the name Geniosil® STP-E30 from Wacker Chemie AG, Germany), 6.0 g of a liquid stabilizer mixture composed of approximately 50% of a sterically hindered amine, mainly composed of bis(1,2,2,6,6-pentamethyl-4-piperidyl)sebacate and methyl 1,2,2,6,6-pentamethyl-4-piperidyl sebacate, as radical trap, approximately 35% of a UV absorber of the benzotriazole type, mainly composed of 2-(2H-benzotriazol-2-yl)-4-methyl-6-dodecylphenol, and approximately 15% of a sterically hindered phenol, mainly composed of branched C₇-C₉ alkyl 3-[3,5-di(tert-butyl)-4-hydroxyphenyl]propionate, as oxidation inhibitor (commercially available under the name Tinuvin® B 75 from Bodo Möller Chemie GmbH, Germany), 150 g of a polypropylene glycol monohydroxy monobutyl ether, with a viscosity at 50° C. of 240 mPa·s and a water content, determined by means of Karl-Fischer titration, of 120 ppm, and 24 g of N-(trimethoxysilylmethyl) O-methylcarbamate (commercially available under the name Geniosil® XL 63 from Wacker Chemie AG, Germany) are mixed with one another in a planetary mixer and stirred for 5 minutes. Subsequently, the batch is completed through the homogeneous incorporation of 80 g of pyrogenic silica with a specific surface of 200 m²/g (commercially available under the name HDK® H18 from Wacker Chemie AG, Germany) and 150 g of polypropylene glycol monohydroxy monobutyl ether, with a viscosity at 50° C. of 240 mPa·s and a water content, determined by means of Karl-Fischer titration, of 120 ppm. Finally, the mixture is stirred for 5 minutes at approximately 100 mbar absolute pressure and, under airtight conditions, drawn off and stored.

Each 50 g of the substance thus obtained was mixed with the amount of phosphorus compound given in table 2 at 3500 rev/min in a mixer from Hauschild, Germany, for a period of time of one minute. Subsequently, test 1 is carried out. The results are found in table 2.

TABLE 2

| | | Amount of | Skinning time | Freedom |
|---|---|---|---|---|
| Example | Catalyst | catalyst [g] | [min] | from tack |
| 1 | (P1) | 0.40 | 20 | 1 |
| 2 | (P2) | 0.45 | >60 | 3 |
| 3 | (P3) | 0.54 | 40 | 2 |
| 4 | (P4) | 0.49 | 10 | 1 |
| 5 | (P5) | 0.66 | 15 | 2 |
| 6 | (P6) | 0.40 | 15 | 2 |
| 7 | (P7) | 0.36 | 15 | 2 |
| C1 | (P8) | 0.51 | >60 | no rubber |
| C2 | (P9) | 0.17 | >60 | no rubber |
| C3 | Tetrabutylphos- | 0.42* | >60 | no rubber |
| | phonium | | | |
| | chloride* | | | |

*as 30% solution in methanol

### Comparative examples 1-3 (C1-C3)

A 40% aqueous solution of tetrabutylphosphonium hydroxide, known as TBP solution (commercially available from Sigma-Aldrich, Germany), and the same molar amount of the acid given in table 3 were mixed and the water was distilled off at 70 to 80° C. down to a pressure of 15-20 mbar. Subsequently, the mixture was cooled down and the product drawn off. The water contents of the products thus obtained, determined by means of Karl-Fischer titration, were in each case less than 1.0%. The phosphorus compounds prepared are combined in table 3.

TABLE 3

| | Amount of | | Amount | |
|---|---|---|---|---|
| | TBP | | of | |
| | solution | | acid | Product |
| Name of the product | [g] | Acid | [g] | appearance |
| Tetra(n-butyl)- | 6.9 | Dodecyl- | 3.26 | Yellow- |
| phosphonium | | benzene- | | brown oil |
| dodecylbenzene- | | sulphonic | | |
| sulfonate (P8) | | acid | | |
| Tetra(n-butyl)- | 6.9 | Cyclohexyl- | 1.28 | Brown oil |
| phosphonium | | boronic | | |
| hydrogen | | acid | | |
| cyclohexyl- | | | | |
| boronate (P9) | | | | |

The working method described in examples 1-7 is repeated, with the amendment that, instead of the phosphorus compounds (P1) to (P7), the compounds (P8), (P9) or tetrabutylphosphonium chloride were used.

The results are found in table 2.

The results in table 2 show that the phosphonium compounds (P1) to (P7) function very well as curing catalysts. The vulcanisates obtained are transparent and colorless and remain unchanged even after storing for 14 days under a Xenon UV lamp.

### Examples 8-11

300 g of a linear polypropylene glycol terminated by trimethoxysilyl groups at both ends (commercially available under the name Geniosil® STP-E35 from Wacker Chemie AG, Germany), 5.0 g of a liquid stabilizer mixture composed of approximately 50% of a sterically hindered amine, mainly composed of bis(1,2,2,6,6-pentamethyl-4-piperidyl)sebacate and methyl 1,2,2,6,6-pentamethyl-4-piperidyl sebacate, as radical trap, approximately 35% of a UV absorber of the benzotriazole type, mainly composed of 2-(2H-benzotriazol-2-yl)-4-methyl-6-dodecylphenol, and approximately 15% of a sterically hindered phenol, mainly composed of branched C₇-C₉ alkyl 3-[3,5-di(tert-butyl)-4-hydroxyphenyl]propionate, as oxidation inhibitor (commercially available under the name Tinuvin® B 75 from Bodo Möller Chemie GmbH, Germany), 100 g of a polypropylene glycol monohydroxy monobutyl ether, with a viscosity at 50° C. of 240 mPa·s and a water content, determined by means of Karl-Fischer titration, of 120 ppm, 10 g of (N-aminoethylaminopropyl)triethoxysilane (commercially available under the name Geniosil®GF 94 from Wacker Chemie AG, Germany), g of N-(dimethoxymethylsilylmethyl) O-methylcarbamate (commercially available under the name Geniosil® XL 65 from Wacker Chemie AG, Germany) and 10 g of (3-glycidoxypropyl)trimethoxysilane (commercially available under the name Geniosil® GF 80 from Wacker Chemie AG, Germany) are mixed with one another in a planetary mixer and stirred for 5 minutes. Subsequently, the batch is completed through the homogeneous incorporation of 30 g of pyrogenic silica with a specific surface of 200 m²/g (commercially available under the name HDK® H18 from Wacker Chemie AG, Germany) and 530 g of a marble flour with a mean particle size (D50%) of 5 μm, a carbonate content of 98%, a specific surface of 1.0 m²/g and an oil absorption value of 16 g/100 g (ISO 787/5). Finally, the mixture is stirred for 5 minutes at approximately 100 mbar absolute pressure and, under airtight conditions, drawn off and stored.

Each 70 g of the substance thus obtained was mixed with the amount of phosphorus compound given in table 4 at 3500 rev/min in a mixer from Hauschild, Germany, for a period of time of one minute. Subsequently, test 1 is carried out. The results are found in table 4.

TABLE 4

| | | Amount of | Skinning time | Freedom from |
|---|---|---|---|---|
| Example | Catalyst | catalyst [g] | [min] | tack |
| 8 | (P1) | 0.11 | 45 | 3 |
| 9 | (P3) | 0.19 | 55 | 2 |
| 10 | (P4) | 0.18 | 35 | 1 |
| 11 | (P7) | 0.12 | 35 | 2 |

The results in table 4 show that the phosphonium compounds (P1), (P3), (P4) and (P7) function very well as curing catalyst.

### Example 12

30 g of a linear polypropylene glycol terminated by trimethoxysilyl groups at both ends (polymer 12)(commercially available under the name Geniosil® STP-E35 from Wacker Chemie AG, Germany) and 0.15 g of phosphorus compound (P7) are mixed at 3500 rev/min in a mixer from Hauschild, Germany, for a period of time of one minute. Subsequently, test 1 is carried out. The results are found in table 5.

### Example 13

30 g of a linear polyurethane exhibiting methoxysilyl groups at both ends (polymer 13) (commercially available under the name “Polymer ST 61” from hanse chemie AG, Germany) and 0.15 g of phosphorus compound (P7) are mixed at 3500 rev/min in a mixer from Hauschild, Germany, for a period of time of one minute. Subsequently, test 1 is carried out. The results are found in table 5.

### Example 14

30 g of a polyurethane exhibiting methoxysilyl groups (polymer 14) (commercially available under the name “Polymer XP ST 75” from hanse chemie AG, Germany) and 0.15 g of phosphorus compound (P7) are mixed at 3500 rev/min in a mixer from Hauschild, Germany, for a period of time of one minute. Subsequently, test 1 is carried out. The results are found in table 5.

TABLE 5

| | Silylated organic | Skinning time | Freedom from |
|---|---|---|---|
| Example | polymer | [min] | tack |
| 12 | Polymer 12 | >60 | 1 |
| 13 | Polymer 13 | >60 | 2 |
| 14 | Polymer 14 | >60 | 1 |

The results in table 5 show that the phosphonium compound (P7) functions very well as curing catalyst with different silylated organic polymers.

1.-10. (canceled)

11. A composition which is crosslinkable by a condensation reaction, comprising an organic polymer with at least one organyloxysilyl radical (A) and
at least one compound (B) of the formula
[R₄P⁺]ₛX^{s-} (I)
in which
s is 1, 2 or 3,
R are identical or different and are optionally substituted hydrocarbon radicals with from 1 to 40 carbon atoms,
X is a group of the formula
O═PR¹ₙ(O⁻)ₘ(OR²)₃₋ₙ₋ₘ (I)
and/or the condensates thereof with one or more P—O—P bonds, or a group of the formula
⁻OC(═O)R^{1′} (III)
in which
R¹ are identical or different and are optionally substituted hydrocarbon radicals optionally interrupted by oxygen atoms,
R^{1′} are identical or different and are optionally substituted hydrocarbon radicals optionally interrupted by oxygen atoms,
n is 0, 1 or 2,
m is 1, 2 or 3 and
m+n is 1, 2 or 3, and
R² are identical or different and are hydrogen atoms or optionally substituted hydrocarbon radicals optionally interrupted by oxygen atoms.

12. The crosslinkable composition of claim 11, wherein radicals Rare hydrocarbon radicals with from 1 to 16 carbon atoms.

13. The crosslinkable composition of claim 11, wherein radicals R¹ are hydrocarbon radicals with from 1 to 50 carbon atoms which are optionally substituted with halogen atoms, amino groups, ether groups, ester groups, epoxy groups, mercapto groups, cyano groups, (poly)glycol radicals or —C(O)O⁻, —P(O)(R′)O⁻, —P(O)(OR′)O⁻, —C(O)OH, —C(O)OR′, —P(O)(R′)OH or —P(O)(OR′)OH groups and which are optionally interrupted by oxygen atoms.

14. The crosslinkable composition of claim 12, wherein radicals R¹ are hydrocarbon radicals with from 1 to 50 carbon atoms which are optionally substituted with halogen atoms, amino groups, ether groups, ester groups, epoxy groups, mercapto groups, cyano groups, (poly)glycol radicals or —C(O)O⁻, —P(O)(R′)O⁻, —P(O)(OR′)O⁻, —C(O)OH, —C(O)OR′, —P(O)(R′)OH or —P(O)(OR′)OH groups and which are optionally interrupted by oxygen atoms.

15. The crosslinkable composition of claim 11, wherein radicals R^{1′} are hydrocarbon radicals with from 1 to 50 carbon atoms optionally substituted with halogen atoms, amino groups, ether groups, ester groups, epoxy groups, mercapto groups, cyano groups, (poly)glycol radicals or —C(O)O⁻, —P(O)(R′)O⁻, —P(O)(OR′)O⁻, —C(O)OH, —C(O)OR′, —P(O)(R′)OH or —P(O)(OR′)OH groups.

16. The crosslinkable composition of claim 12, wherein radicals R^{1′} are hydrocarbon radicals with from 1 to 50 carbon atoms optionally substituted with halogen atoms, amino groups, ether groups, ester groups, epoxy groups, mercapto groups, cyano groups, (poly)glycol radicals or —C(O)O⁻, —P(O)(R′)O⁻, —P(O)(OR′)O⁻, —C(O)OH, —C(O)OR′, —P(O)(R′)OH or —P(O)(OR′)OH groups.

17. The crosslinkable composition of claim 13, wherein radicals R^{1′} are hydrocarbon radicals with from 1 to 50 carbon atoms optionally substituted with halogen atoms, amino groups, ether groups, ester groups, epoxy groups, mercapto groups, cyano groups, (poly)glycol radicals or —C(O)O⁻, —P(O)(R′)O⁻, —P(O)(OR′)O⁻, —C(O)OH, —C(O)OR′, —P(O)(R′)OH or —P(O)(OR′)OH groups.

18. The crosslinkable composition of claim 11, wherein anions X are acylate groups or phosphinate groups.

19. The crosslinkable composition of claim 12, wherein anions X are acylate groups or phosphinate groups.

20. The crosslinkable composition of claim 13, wherein anions X are acylate groups or phosphinate groups.

21. The crosslinkable composition of claim 15, wherein anions X are acylate groups or phosphinate groups.

22. The crosslinkable composition of claim 11, comprising:
(A) an organic polymer containing at least one group of the formula
—SiR³ₐ(OR⁴)₃₋ₐ (IV)
in which
R³ are identical or different and are an optionally substituted hydrocarbon radical optionally interrupted by oxygen atoms,
R⁴ are identical or different and are a hydrogen atom or an optionally substituted hydrocarbon radical and
a is 0, 1 or 2,
(B) at least one compound of the formula (I),
(C) optionally, one or more crosslinking agents,
(D) optionally, one or more plasticizers,
(E) optionally, one or more fillers,
(F) optionally, one or more bonding agents, and
(G) optionally, one or more further additives.

23. The crosslinkable composition of claim 11, wherein at least one polymer (A) is an organic polymer containing organyloxysilyl groups which comprises, as a polymer chain, polyoxyalkylenes, hydrocarbon polymers, polychloroprenes, polyisoprenes, polyurethanes, polyesters, polyamides, polyacrylates, polymethacrylates, vinyl polymers and polycarbonates.

24. The crosslinkable composition of claim 11, wherein component (A) comprises one or more polyoxyalkylenes (A1) comprising repeat units of the formula
—R⁷—O— (V)
in which
R⁷ are identical or different and are an optionally substituted divalent linear or branched hydrocarbon radical with from 1 to 12 carbon atoms.

25. The crosslinkable composition of claim 11, wherein component (A) comprises one or more polyacrylates (A2) comprising repeat units of the formula
—CH₂—C(R⁸)(COOR⁹)— (VI)
in which
R⁸ are identical or different and are hydrogen atoms or methyl radicals and
R⁹ are identical or different and are optionally substituted monovalent hydrocarbon radicals.

26. A molded article, prepared by crosslinking a composition of claim 11.
